(19) United States
(12) Patent Application Publication
(10) Pub. No.: US 2009/0105405 A1
(43) Pub. Date: Apr. 23, 2009

(54) USE OF POLYVINYL ACETALS AS A LOW-PROFILE ADDITIVE

(75) Inventors: Rene Graewe, Landshut (DE); Thomas Lehmann, Sinzing (DE)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO. KG, Burghausen (DE)

(21) Appl. No.: 12/293,204

(22) PCT Filed: Feb. 28, 2007
(86) PCT No.: PCT/EP07/51862

§ 371 Date: Dec. 11, 2008

(30) Foreign Application Priority Data
Mar. 16, 2006 (DE) 10 2006 012 200.3

(51) Int. Cl. C08L 33/04

(52) U.S. Cl. 524/539; 525/451

(57) ABSTRACT

Polyvinyl acetals prepared by acetalizing a hydrolyzed polyvinyl acetate homo- or copolymer with at least one of formaldehyde, acetaldehyde, propionaldehyde, or butyraldehyde are low profile additives in unsaturated polyester molding resins which still provide a uniform pigment distribution in molded parts.

The invention relates to the use of polyvinyl acetals as low profile additive.

In the production of two-dimensional plastic moldings, unsaturated polyester resin compositions (UP resins) are often employed. These polyester resins are reaction products of a dicarboxylic acid or a dicarboxylic acid anhydride with a polyol. Such polyester resin compositions also contain a monomer having ethylenically unsaturated groups, generally styrene. Styrene is added to the polyester resin composition in order to dissolve the polyester and to guarantee that the polyester composition is a flowable material. To reinforce the plastic moldings obtained with the polyester resin composition, the polyester resin compositions also contain fiber materials such as glass fiber, carbon fiber, or corresponding fiber mats.

The volume shrinkage during heat curing of the polyester resin is problematic when processing such polyester resin compositions (Fiber Reinforced Plastic composites=FPR composites). In order to reduce the shrinkage during hardening of the polyester resin, so-called low profile additives are added to it. The low profile additive reduces shrinkage during hardening, relieves internal stresses, lessens the formation of microcracks, and facilitates the adherence to manufacturing tolerances. The low profile additives are thermoplastic materials, such as polystyrene, polymethyl methacrylate, and in particular polyvinyl acetate, which often also contain carboxyl-functional comonomer units.

A disadvantage with the low profile additives used thus far is that with pigmented composite component parts, they cause marbling of the surface of the component parts. The component parts therefore have to be varnished.

Against this background, the object was to provide low profile additives, which lead to an effective reduction of the amount of shrinkage and thereby effect an improved pigmentation of the component parts.

Subject matter of the invention is the use of polyvinyl acetals as low profile additive.

Polyvinyl acetals that are obtained, starting with polyvinyl acetate, by hydrolyzing the polyvinyl acetate to a degree of hydrolysis of ≧50 mol and subsequently acetalizing it with one or more aliphatic or aromatic aldehydes having 1 to 15 C atoms are used as polyvinyl acetals.

The polyvinyl acetates are produced by methods known to those skilled in the art. Vinyl acetate homopolymers or copolymers having one or more monomers from the group comprising ethylenically unsaturated mono- and dicarboxylic acids, for example acrylic acid, methacrylic acid, crotonic acid, and maleic acid, are preferred as starting materials. If starting with vinyl acetate copolymers, they preferably contain 0.1 to 10% by weight of carboxyl-functional comonomer units.

These vinyl acetate polymers can be prepared in known manner by means of polymerization; preferably by bulk polymerization, suspension polymerization, or by polymerization in organic solvents, particularly preferably in an alcoholic solution. Suitable solvents and modifiers are for example methanol, ethanol, propanol, isopropanol. The polymerization is performed at reflux at a temperature of 50° C. to 100° C. and is initiated radically by adding common initiators.

Examples for common initiators are percarbonates, such as cyclohexyl peroxy dicarbonate, or perester, such as t-butyl perneodecanoate or t-butyl perpivalate. The adjustment of the molecular weight can occur in known manner by addition of a modifier, by means of the solvent content, by variation of the initiator concentration, and by variation of the temperature. After completion of the polymerization, the solvent and excess monomer and modifier, if necessary, are removed by distillation.

Saponification of the vinyl acetate polymers occurs in a manner known per se, for example according to the belt or kneader process, in an alkaline or acidic medium with addition of acid or base. Preferably, the vinyl ester solid resin is contained in alcohol, for example methanol, the solids content being adjusted to 15 to 70% by weight. The hydrolysis is preferably performed in a basic medium, for example by addition of NaOH, KOH, or NaOCH₃. The base is generally used in a quantity of 1 to 5 mol % per mol of ester units. The hydrolysis is performed at temperatures of 30° C. to 70° C. After completion of the hydrolysis, the solvent is removed by distillation and the polyvinyl alcohol is obtained as a powder. The polyvinyl alcohol can also be obtained as an aqueous solution by successive addition of water while the solvent is removed by distillation.

The partially or fully saponified vinyl ester polymers obtained in this manner have a degree of hydrolysis of preferably ≧50 mol %, especially preferably 70 to 100 mol %, most preferably 95 to 100 mol %.

For acetalizing, the partially or fully saponified polyvinyl acetates are preferably contained in an aqueous medium. Acetalizing occurs in the presence of acidic catalysts such as hydrochloric acid, sulfuric acid, nitric acid, or phosphoric acid. The pH of the solution is preferably adjusted to values <1 by adding 20% hydrochloric acid. After addition of the catalyst, the solution is preferably cooled to −10° C. to +5° C. The acetalization reaction is started by adding the aldehyde portion.

Preferred aldehydes from the group of aliphatic and aromatic aldehydes having 1 to 15 C atoms are formaldehyde, acetaldehyde, propionaldehyde, and most preferred butyraldehyde, or a mixture of butyraldehyde and acetaldehyde. The added amount of aldehyde depends on the desired degree of acetalization. Since the acetalization takes place with almost complete conversion, the added amount may be determined by means of simple stoichiometric calculation. After finishing the addition of the aldehyde, the acetalization is completed by heating the batch to 20° C. to 60° C. and stirring for several hours, preferably 1 to 6 hours, and the powdery reaction product is isolated by filtration and a downstream washing step.

The polyvinyl acetals have a degree of acetalization of 1 to 90 mol %, preferably 45 to 90 mol %. Polyvinyl butyrals are preferred. Polyvinyl butyrals with 75 to 87% by weight of vinyl butyral units, 10 to 25% by weight of vinyl alcohol units, and 0 to 5% by weight of vinyl acetate units are most preferred.

For use as low profile additive, the polyvinyl acetals are generally dissolved in styrene and optionally applied with additional additives such as fillers, thickening agents, initiators, and processing aids. The polyvinyl acetals can also be used in combination with conventional low profile additives. For example in combination with polyvinyl acetate, carboxyl-functional polyvinyl acetates, and polymethyl methacrylate.

The polyvinyl acetals are suitable as low profile additive for all common production methods of FRP composites, such as Sheet Molding Compound Technology (SMC), Bulk Molding Compound Technology (BMC), Resin Transfer Molding (RTM), Resin Injection Molding (RIM). The composition of the recipes and the amounts of the low profile additives used depend on the production method chosen and are known to those skilled in the art. The polyvinyl acetal is generally applied in a 10 to 50% by weight solution in styrene. The amount used is generally 5 to 50 parts by weight, preferably 30 to 40 parts by weight of the solution, based on the total recipe.

The following examples serve to further explain the invention:

| | | Parts By |
|---|---|---|
| Type | Raw Material | Weight |
| Palapreg P 18-03 | UP resin (34.5% in styrene) | 65.5 |
| LPAX | LPA (40% in styrene) | 30.0 |
| Styrene | Monostyrene | 4.5 |
| Trigonox ® C | Tert-butyl peroxy benzoate | 1.5 |
| Byk ®-W 996 | Wetting and dispersing | 2.9 |
| | additive | |
| p-Benzoquinone | Inhibitor (10% in MMA) | 0.7 |
| Akzo Nobel NL-49 | Accelerator (1% Co in ester) | 1.1 |
| Byk ®-9076 | Wetting and dispersing | 0.5 |
| | additive | |
| Carbon black | Coloring paste black | 10.0 |
| 9257-45 | | |
| Millicarb ® OG | Chalk (CaCO₃) | 200.0 |
| Subtotal | | 316.7 |
| Luvatol ® MK35 | Thickening agent (35% MgO in | 1.5 |
| | UP) | |
| Vetrotex P204 | Glass fiber | 85.9 |

As low profile additive was used:

### LPA1 (Comparison):

Carboxyl-functional polyvinyl acetate solid resin

### LPA2:

Polyvinyl butyral with 84% by weight of vinyl butyral units, 15% by weight of vinyl alcohol units, and 1% by weight of vinyl acetate units.

A paste was kneaded from the raw materials listed in the table. Shortly before processing, Luvatol MK 35, a thickening agent, was mixed in. Afterwards, a hand lay-up laminate was made with the paste and with the glass fibers and processed into a SMC. The product was stored for 3 days at 20° C. and 50% room humidity. Afterwards, it was molded at 160° C. in a common SMC press into a component part.

The shrinkage was determined after cooling down of the press and the volume change in percent was identified. Minus values indicate that the component part was larger than the original shape.

TABLE 1

| | x | | | | | y | | | | |
|---|---|---|---|---|---|---|---|---|---|---|
| | Deviation | Length | | Shrinkage | | Deviation | Length | | Shrinkage | |
| LPAX | [mm] | [mm] | α [μ/μK] | [%] | σ | [mm] | [mm] | α [μ/μK] | [%] | σ |
| LPA1 | 0.397 | 457.392 | 9.04E−06 | −0.42 | 0.016 | 0.456 | 457.451 | 8.01E−06 | −0.55 | 0.02 |
| LPA2 | 0.309 | 457.304 | 1.06E−05 | −0.23 | 0.018 | 0.375 | 457.370 | 9.42E−06 | −0.37 | 0.03 |

As can be seen from Table 1, the effect of polyvinyl butyral as LPA is comparable with common, carboxyl-functional polyvinyl acetate. Both cause in the formulation an expansion during molding.

### Pigmentability:

The degree of pigmentability can only be evaluated optically in comparison to a reference. A polystyrene sample that allows good pigmentation but shows no expansion in the formulation serves as reference.

| Sample | Evaluation (1-6) 1 = best |
|---|---|
| Polystyrene | 1 |
| LPA 1 (comparison) | 6 |
| LPA 2 | 3 |

Polyvinyl butyral shows significantly improved pigmentation compared to carboxylated polyvinyl acetate solid resin.

1.-7. (canceled)

8. In a molding composition comprising at least one unsaturated polyester resin, the improvement comprising incorporating into said molding composition at least one polyvinylacetal low profile additive prepared by hydrolyzing a polyvinyl acetate homopolymer or copolymer to a degree of hydrolysis of at least 50 mol % based on vinyl acetate-derived moieties to form a polyvinyl alcohol homopolymer or copolymer, and subsequently acetalizing the polyvinyl alcohol homopolymer or copolymer with at least one aldehyde selected from the group consisting of formaldehyde, acetaldehyde, propionaldehyde, and butyraldehyde.

9. The molding composition of claim 8, wherein the polyvinyl alcohol homopolymer or copolymer is acetalized with acetaldehyde, butyraldehyde, or a mixture thereof.

10. The molding composition of claim 8, wherein the polyvinylacetal comprises a polyvinylbutyral.

11. The molding composition of claim 8, wherein at least one polyvinyl acetal is a copolymer containing 75-87 weight percent of vinyl butyral units, 10-25 weight percent vinyl alcohol units, and 0-5 weight percent vinyl acetate units.

12. The molding composition of claim 8, wherein at least one low profile additive which is not a polyvinyl acetal is present.

13. The molding composition of claim 8, wherein the polyvinyl acetate homopolymer or copolymer is a copolymer containing vinyl acetate-derived units and units derived from an unsaturated mono- or dicarboxylic acid.

14. The molding composition of claim 13, wherein units derived from at least one of acrylic acid, methacrylic acid, crotonic acid, and maleic acid are present.

15. The molding composition of claim 13, wherein the unsaturated mono- or dicarboxylic acid-derived units are present in an amount of 0.1 to 10 weight percent based on the weight of the polyvinylacetate copolymer.

16. The molding composition of claim 8, which further comprises styrene monomer.

17. The molding composition of claim 8, which contains reinforcing fibers, and is a sheet molding compound, bulk molding compound, resin transfer molding compound, or reaction injection molding compound.

18. The molding composition of claim 8, further comprising at least one solid particulate pigment.

19. A molded article produced by curing a composition of claim 8.

20. A molded article, produced by curing a composition of claim 9.

21. A molded article, produced by curing a composition of claim 11.

22. A process for producing a molding composition of claim 8, comprising providing at least one unsaturated polyester resin, dissolving said polyvinyl acetal low profile additive in styrene to form a styrenic low profile additive composition, and incorporating the styrenic low profile additive composition into the unsaturated polyester resin.
